(19) United States
(12) Patent Application Publication
(10) Pub. No.: US 2009/0307408 A1
(43) Pub. Date: Dec. 10, 2009

(54) Peer-to-Peer Embedded System Communication Method and Apparatus

(76) Inventor: Rowan Nigel Naylor, Basingstoke (GB)

Correspondence Address: COATS & BENNETT, PLLC, 1400 Crescent Green, Suite 300, Cary, NC, 27518, US

(21) Appl. No.: 12/135,278

(22) Filed: Jun. 9, 2008

(51) Int. Cl. G06F 13/00

(52) U.S. Cl. 710/317

(57) ABSTRACT

According to one embodiment, an embedded system includes at least one processor, memory and peripheral subsystem. Each subsystem has a terminating node configured to issue and receive messages for the subsystem. A bus fabric interconnects the subsystems and includes a plurality of non-terminating nodes located at different points in the bus fabric and interconnected with the terminating nodes to form a peer-to-peer communication matrix between the subsystems. The non-terminating nodes route the messages over the peer-to-peer matrix so that instructions included in the messages are delivered to the terminating nodes identified in the messages for execution. Each node is assigned one or more unique object identifiers for identifying the nodes and the instructions included in the messages identify different control and data flow functions supported by different ones of the subsystems.

### TECHNICAL FIELD

The present invention generally relates to embedded systems, and more particularly relates to communication between subsystems of an embedded system.

### BACKGROUND

Embedded systems are special-purpose computer systems designed to perform one or more dedicated functions. For example, some types of embedded system include cell phones, handheld devices, calculators, GPS (global positioning system) receivers, printers, network devices, digital cameras, controllers, etc. Embedded systems are often fabricated on a single semiconductor substrate typically referred to as a System-on-Chip (SoC) or Network-on-Chip (NoC) system. Embedded systems are often highly complex, including multiple processor-based subsystems. The processor subsystems often share common resources such as memory, busses and peripherals to improve system cost and reduce power and packaging constraints. However, a greater burden is placed on the processor subsystems as the number of subsystems increases and more resources are shard. For example, one or more of the processor-subsystems must arbitrate requests for the same common resource and maintain data coherency. As the number of processor subsystems increases, so to does the complexity of the arbitration and coherency processes that must be managed. Packaging constraints such as pin count often result in external memory resources also being shared, further complicating the arbitration and coherency schemes.

In addition to managing the use of shared resources, the processor subsystems must also be aware of which subsystems are powered down during low power or sleep modes. Otherwise, erroneous system operation may result. As a result, embedded system design is often a tradeoff between many variables such as bandwidth, efficiency, system performance, power consumption and cost. Bandwidth and power are of particular concern for handheld and mobile embedded systems where the processor subsystems are under a greater burden to meet performance requirements created by increasingly higher user demand.

The processor subsystems attempt to meet increasing user demand, but in doing so place a greater stress on the underlying embedded support system. Mainly, the internal bus architecture or ‘bus fabric’, together with embedded subsystems such as DMA (direct memory access) controllers and interrupt handlers, have a greater burden for providing transparent and efficient use of limited common resources. However, conventional bus fabrics are not fully transparent, requiring a central process to manage resource use at a relatively low level. For example, one or more processor subsystems are conventionally responsible for low-level functions such as data flow (including DMA), arbitration, interrupt handling, inter-processor communication, power management, etc. This results in a master-slave type arrangement. Yet, the processor subsystems must also satisfy stringent embedded system performance requirements, requiring a greater emphasis on higher-level functions. Allocating limited processor resources between low-level and high-level functions has a tremendous affect on overall embedded system performance. For example, processor subsystems become slow and cannot efficiently handle high-level tasks when too many processor resources are allocated to low-level master-slave functions. On the other hand, bottlenecks arise in the bus fabric and between shared resources when too few processor resources are allocated to the low-level tasks.

Conventional embedded bus fabric architectures are based on a master-slave arrangement where main components such as the DMA unit of a processor are bus masters and originate bus traffic. They communicate to bus slaves such as memory, peripherals (UART, USB etc.). The bus slaves cannot generate traffic and only respond to memory requests from a master. The bus master accesses slave devices with two functions, either read or write. In both cases the transfer originates with the master and is controlled across the bus fabric by the master. Additional functionality in slave devices is achieved using memory mapped registers that can be read and/or written to drive the additional functions.

The bus fabric is structured as a memory space where all slave devices are assigned a physical address, the address being issued as part of a memory read/write by the master to identify the device it wants to access. Each master in the system does not have an address or assigned location within the memory map unless the master also has a slave port as is the case with certain devices like accelerators such as a DMA unit. Conventional bus systems include the ability to pipeline operations and share bus data paths between masters (e.g., interleaving, out of order data transfer, etc.) but these abilities are aimed at increasing efficiency and do not change the fundamental master-slave operation of the bus design.

### SUMMARY

According to the methods and apparatus taught herein, control and data flow functions are managed in an embedded system using a peer-to-peer access scheme instead of a master-slave topology. In doing so, such low-level functions are distributed more evenly across the system. This frees up processor resources for higher-level functions, improving embedded system performance without creating bottlenecks in the bus fabric or between subsystems. The bus fabric may include any preexisting type of bus structures. A peer-to-peer communication matrix is formed using the bus structures by inserting communication nodes at different points in the bus fabric. These nodes, referred to herein as non-terminating nodes, are interconnected with terminating nodes associated with the subsystems (e.g., memory, processors, peripheral, etc.) to complete the peer-to-peer matrix. The peer-to-peer matrix enables all subsystems to communicate with the bus fabric on the same level. The subsystems request execution of low-level control and data flow tasks by issuing messages to the other subsystems. The messages are routed over the peer-to-peer matrix by the non-terminating nodes until arriving at the proper destination for execution. The non-terminating nodes also manage other functions such as arbitration and interrupt handling, alleviating the processor subsystems of these tasks.

According to one embodiment, an embedded system includes at least one processor, memory and peripheral subsystem. Each subsystem has a terminating node configured to issue and receive messages for the subsystem. A bus fabric interconnects the subsystems and includes a plurality of non-terminating nodes located at different points in the bus fabric and interconnected with the terminating nodes to form a peer-to-peer communication matrix between the subsystems. The non-terminating nodes route the messages over the peer-to-peer matrix so that instructions included in the messages are delivered to the terminating nodes identified in the messages for execution. Each node is assigned one or more unique object identifiers for identifying the nodes and the instructions included in the messages identify different control and data flow functions supported by different ones of the subsystems.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a block diagram of an embodiment of an embedded system.

FIG. 2 is a diagram of an embodiment of a messaging format employed in an embedded system.

FIG. 3 is a block diagram of an embodiment of an embedded system during a data flow operation.

FIG. 4 is a block diagram of an embodiment of an embedded system during another data flow operation.

FIG. 5 is a diagram of an embodiment of a multi-word message employed in an embedded system.

FIG. 6 is a diagram of another embodiment of a messaging format employed in an embedded system.

FIG. 7 is a block diagram of another embodiment of an embedded system.

FIG. 8 is a block diagram of yet another embodiment of an embedded system.

FIG. 9 is a block diagram of still another embodiment of an embedded system.

### DETAILED DESCRIPTION

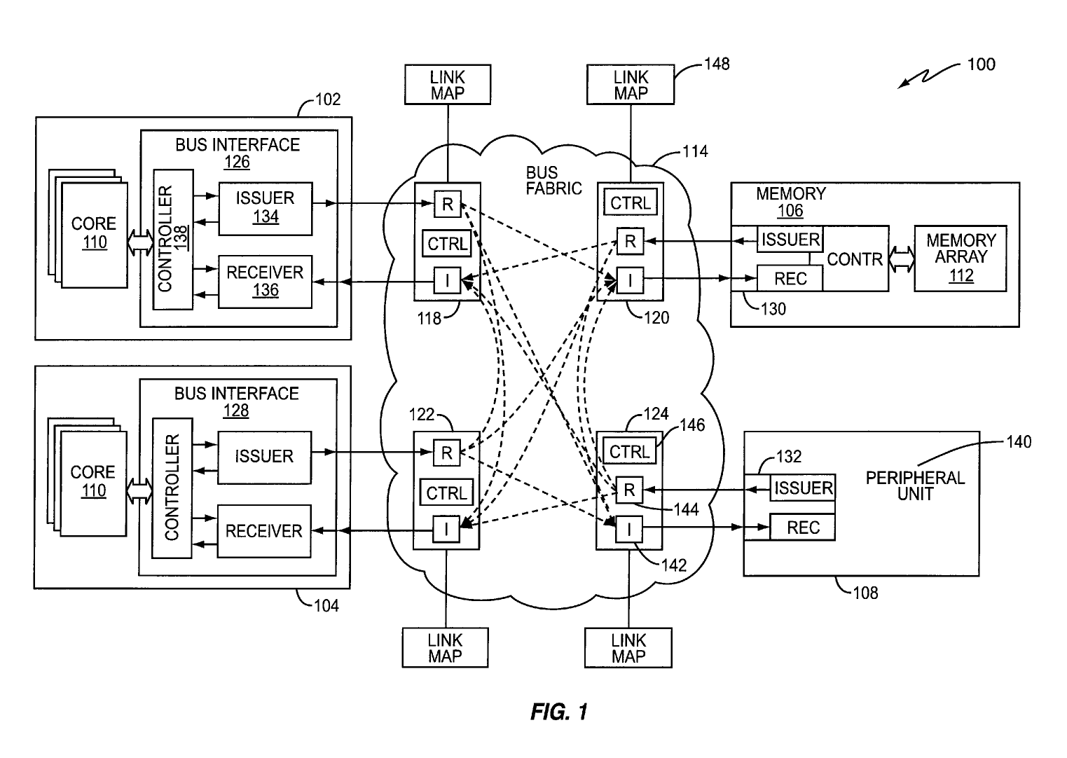

FIG. 1 illustrates an embodiment of an embedded system 100. The embedded system 100 includes a plurality of processor subsystems 102, 104, at least one memory subsystem 106 and at least one peripheral subsystem 108. Each processor subsystem 102, 104 includes one or more processor cores 110 for executing program code that enables the function or functions supported by the embedded system 100. Each memory subsystem 106 has an array 112 for storing information. Each peripheral subsystem 108 expands the functionality of the processor subsystems 102, 104 and enhances overall embedded system operation. The subsystems 102-108 are interconnected by a bus fabric 114. The bus fabric 114 may include any number and type of interconnected bus structures. The buses may be low-speed, high-speed, serial, parallel or any combination thereof. The subsystems 102-108 communicate with the bus fabric 114 on the same level in a peer-to-peer manner instead of a master-slave arrangement. Accordingly, the management and control of low-level functions involving the bus fabric 114 such as data flow (including DMA), arbitration, interrupt handling, inter-processor communication, power management and the like are distributed more evenly across the subsystems 102-108 and bus fabric 114. This frees-up processor subsystem resources for higher-level functions, improving overall system performance without creating bottlenecks within the bus fabric 114 or between subsystems 102-108.

In more detail, the bus fabric 114 includes a plurality of nodes 118-124 located at different points in the fabric 114. Each node 118-124 of the bus fabric 114 is connected to other nodes within the fabric 114, to nodes 126-132 associated with the subsystems 102-108, or both. Interconnecting the nodes 118-132 this way creates a peer-to-peer communication matrix formed between the subsystems 102-108. Messages are routed from one subsystem 102-108 to another over the peer-to-peer matrix irrespective of the underlying bus topology. This way, peer-to-peer access can occur within the embedded system 100 using any type of preexisting bus architectures. In one embodiment, connections between the nodes 118-132 are unidirectional and either point-to-point or point-to-multi-point. A node 118-132 can be connected to the peer-to-peer matrix using any underlying bus structure (not shown) capable of transferring messages. The underlying bus structure also carries a clock for synchronous operation, strobes for delineating and transferring the messages and control signals such as wait, ready and acknowledge signals for controlling message flow. Other bus lines can be used to indicate the structure of the messages as will be described in more detail later. Any number of conventional bus protocols can be used to implement the access scheme.

The messages are routed over the peer-to-peer matrix based on unique object identifiers included in the messages. Each node 118-132 is identified using one or more of the unique object identifiers, not an address space. As such, memory mapping is not needed each time a node 118-132 is added, deleted or otherwise modified. Instead, the nodes 118-132 need only be aware of which object identifiers are valid. Multiple unique object identifiers can be assigned to the same node 118-132 for identifying a different function or group of functions supported by the corresponding subsystem 102-108. This way, different functions supported by the same subsystem 102-108 can be accessed using different object identifiers assigned to the same subsystem 102-108. The subsystems 102-108 can be re-used in other embedded designs without substantive software or hardware revisions when the object identification techniques disclosed herein are used for subsystem identification instead of a memory mapping technique.

In addition to having unique object identifiers, the messages also include instructions corresponding to low-level functions to be executed by the receiving terminating nodes 126-132. Each instruction identifies which function or functions should be executed, the node 126-132 to execute the instruction and data associated with the function(s). One or more instructions can be included in a single message. Each node 118-132 is capable of handling received messages, whether by processing the instructions included in the messages, routing the messages over the peer-to-peer matrix or performing other tasks such as arbitration or interrupt handling. If a node 118-132 cannot execute one or more instructions included in a received message, the receiving node issues a message to the originating node indicating that the receiving node is not configured to execute the instruction(s).

Messages originate and terminate at the subsystem nodes 126-132, hereinafter referred to as terminating nodes. Each terminating node 126-132 comprises an issuer 134, a receiver 136 and an interface controller 138. The issuer 134 generates new messages and sends the messages to the bus fabric 114. Messages are received from the bus fabric 114 by the receiver 136 and decoded. The interface controller 138 manages interaction between the corresponding subsystem 102-108 and the issuer and receiver 134, 136. The interface controller 138 receives commands from the subsystem 102-108 identifying new instructions. In response, the interface controller 138 instructs the issuer 134 to generate new messages including the instructions. The interface controller 138 also accepts decoded messages from the receiver 136 and initiates the instructions included in the decoded messages. The instructions are passed to the subsystem 102-108 for execution when appropriate. The interface controllers 138 can be integrated as part of the subsystem logic or can be add-on components. For example, FIG. 1 shows add-on interface controllers 138 for the processor and memory subsystems 102, 104, 106 while the controller function is integrated with other logic 140 that forms the peripheral subsystem 108. Regardless, the nodes 118-124 included in the bus fabric 114 route the messages from node-to-node over the peer-to-peer matrix and are hereinafter referred to as non-terminating nodes.

Each non-terminating node 118-124 similarly comprises an issuer 142, a receiver 144 and an interface controller 146. The receiver 144 passes messages received from one of the terminating nodes 126-132 to one or more other ones of the non-terminating nodes 118-124. The issuer 142 receives messages from one or more other ones of the non-terminating nodes 118-124 and passes the messages to one of the terminating nodes 126-132. The interface controller 146 determines how the messages are routed. The interface controller 146 included in the non-terminating nodes 118-124 may perform other tasks such as interrupt handling and arbitration, alleviating the processor subsystems 102, 104 of these tasks. The main role of the non-terminating nodes 118-124 is routing messages from source to destination over the peer-to-peer matrix. Messages can be routed from a single source to a single destination. Alternatively, the non-terminating nodes 118-124 can receive a message and decode the routing destination not as a single terminating node but as a group of terminating nodes connected by a common factor in their respective node identities. This enables the non-terminating nodes 118-124 to broadcast messages for system or group wide functions such as reset.

According to one embodiment, the interface controller 146 included in the non-terminating nodes 118-124 determines a preferred routing path by accessing a link map 148 associating the unique object identifiers with different routing paths. In one embodiment, the link map 148 is fixed in hardware. In another embodiment, the link map 148 is a programmable routing table arranged similar to a conventional IP network routing table. Conventional routing tables include at least the destination network ID, cost of the path through which the packet is to be sent and the next network station to which the packet is to be sent on the way to destination. However, the link map 148 accessed by the non-terminating nodes 118-124 corresponds to embedded system messages and not IP packets. Also, the link map 148 can be used along with accumulated statistics to determine arbitration priority. The link map 148 can be used in this way to balance system latencies. In one embodiment, the link map 148 is modified to reflect a new arbitration scheme or to reprioritize the current arbitration scheme. For example, the arbitration scheme or priority may be change when a portion of the bus fabric 114 is disabled, e.g., when the bus fabric 114 is powered down or placed in a low power mode such as sleep mode. In one embodiment, one or more of the nodes 118-132 in the peer-to-peer matrix issues a message configured to update the link map 148 when part of the bus fabric 114 is disabled. This way, messages are not routed through non-terminating nodes 118-124 located in the disabled portion of the bus fabric 114. Modifying the arbitration scheme or priority in this way also enables the embedded system 100 to maintain acceptable throughput levels even though part of the bus fabric 114 is disabled, thus better balancing system latencies.

In another embodiment, messages are routed by the non-terminating nodes 118-124 based on status and traffic information exchanged between the non-terminating nodes 118-124. The information may be used to automatically modify the fabric arbitration scheme or priority so that new routes are created when bottlenecks occur within the bus fabric 114 or between the subsystems 102-108. New routes may also be created when sections of the bus fabric 114 are in sleep or power down operation or otherwise disabled. Routes that avoid disabled regions of the bus fabric 114 may be pre-programmed into the non-terminating nodes 118-124 to address known fixed system power saving states or application specific states. For example, low latency paths can be automatically created through the bus fabric 114 when particular operating states occur. This information may also be used to better balance system latencies by modifying the fabric arbitration scheme or priority accordingly.

In yet another message routing embodiment, a dedicated controller is provided for managing the bus fabric 114, modifying the fabric arbitration scheme or priority and/or reconfiguring the routing paths of the peer-to-peer matrix based on changes in subsystem activity. The dedicated controller can be part of a non-terminating node 118-124 or can be a stand-alone controller (not shown). In either case, the dedicated controller receives status messages originated by the terminating nodes 126-132 indicating subsystem activity. The non-terminating nodes 118-124 may also issue messages to the dedicated controller for indicating bus fabric activity. In response, the dedicated controller issues messages that tailor the behavior of the bus fabric 114 to particular power and application demands. The distributed nature of the peer-to-peer matrix allows the dedicated controller to function transparently with respect to the processor subsystems 102, 104. In still another embodiment, message routing information is hard-wired into each non-terminating node 118-124. In each of these embodiments, the non-terminating nodes 118-124 route messages from source to destination over the peer-to-peer matrix so that instructions included in the messages can be executed in a more distributed and timely manner across the bus fabric 114 and the subsystems 102-108.

The instructions included in the messages not only support conventional read and write data flow functions, but other data flow functions and certain control functions. The instructions can broadly relate to any type of low-level control and data flow function such as reads/writes, DMA, arbitration, interrupt handling, inter-processor communication, power management, etc. The terminating nodes 126-132 directly execute low-level functions indicated by the instructions included in the messages routed over the peer-to-peer matrix, improving data transfer, automating common processes and reducing the need for centralized control. The peer-to-peer access techniques disclosed herein enable low-level functions to be distributed more evenly across the bus fabric 114 and subsystems 102-108.

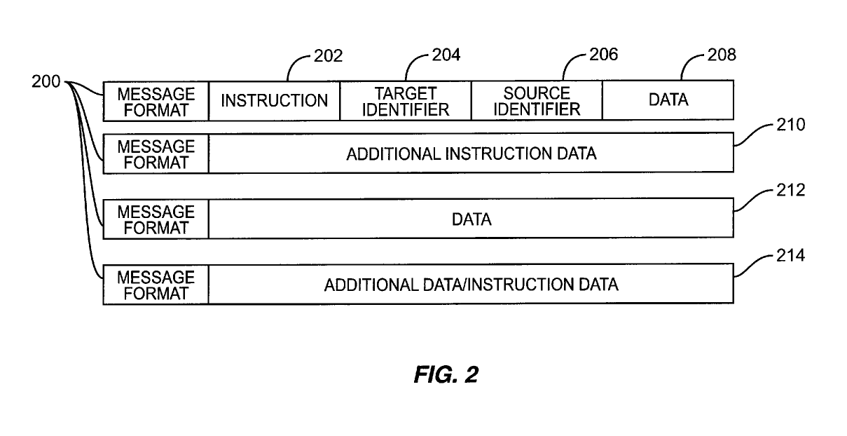

FIG. 2 illustrates an embodiment of a peer-to-peer messaging format. According to this embodiment, the messages have several fields 200-214. The first field 200 identifies the message format. Under some conditions, a message may span more than one word. For example, multiple instructions may be included in the message. Also, the structure of the bus fabric 114 has a definable width. Thus, the messages may be included in a single word or split over a series of sequential words depending on the dimension of the bus fabric 114. The first field 200 identifies whether the message is a single word or multi-word message. The message may be split over several sequential words when a narrow bus topology is employed. In wider bus topologies, some messages can be contained in a single word. The first field 200 indicates the number of words occupied by a message.

The second field 202 identifies the instruction to be executed. The instruction can correspond to one of several supported control and data flow functions. Several basic instructions are available. Additional instructions may also be supported depending on the type of embedded system 100. One of the base instructions is the READ instruction. The READ instruction requests a target node to provide data. The target node is identified in the third field 204 of the message (the issuing node may be identified in an optional fourth field 206). A data field 208 of the message gives further specifics such as an address within an address space of the target node, number of words, and additional actions after the data is sent. In one embodiment, the terminating node 130 associated with the memory subsystem 106 can use the data field to store the address of required data so that conventional memory mapping can be transparently implemented without processor subsystem control.

Another base instruction is the WRITE instruction. The WRITE instruction requests the node identified in the third field 204 to store data included in the data field. The data field 208 may also include further details relating to the WRITE instruction. The access scheme can also be used to maintain coherency when read and write instructions are issued. In one embodiment, the terminating node 130 of the memory subsystem 106 issues a message to the processor subsystems 102, 104 indicating when a shared region of the memory array 112 has been accessed as a result of a READ, WRITE or other memory-based instruction. In one embodiment, the memory subsystem 106 maintains a map (not shown) identifying different shared regions of the memory array 112 to determine whether a shared region of the array 112 has been accessed.

DMA read and write instructions are also supported. The data field 208 indicates the target node for the DMA operation and other setup information. The DMA instructions cause the node identified in the third field 204 to directly initiate a read or write operation with the node indicated in the data field 208 as part of a DMA-type transfer. One of the processor subsystem terminating nodes 126, 128 can initiate a DMA exchange between peripheral and memory subsystems 106, 108 by issuing a DMA instruction. In response, the terminating nodes 130, 132 of the peripheral and memory subsystems 106, 108 directly execute the DMA exchange over the peer-to-peer matrix without intervention from the processor subsystems 102, 104.

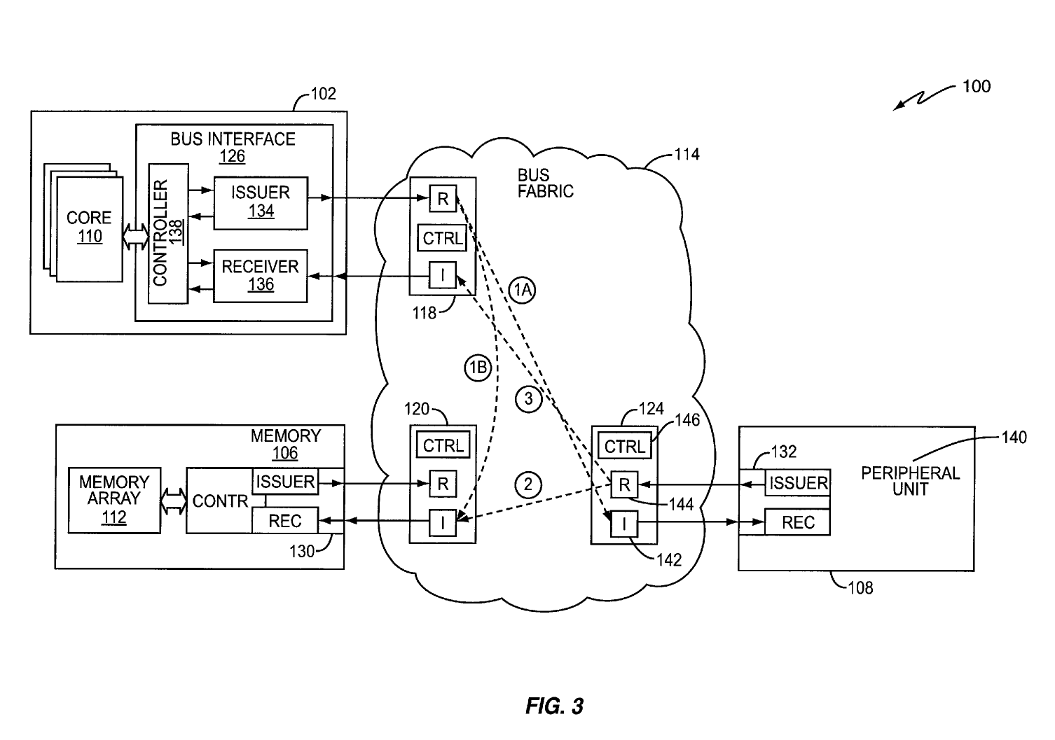

FIG. 3 illustrates one embodiment where the terminating node 126 of the first processor subsystem 102 configures the terminating nodes 120, 124 of both the memory subsystem 106 and the peripheral subsystem 108 for a DMA exchange by issuing a message to both terminating nodes 120, 124 as indicated by the dashed lines labeled 1A and 1B. Once configured, the terminating node 124 of the peripheral subsystem 108 can send data over the peer-to-peer matrix to the terminating node 120 of the memory subsystem 106 as indicated by the dashed line labeled 2. In response, the memory subsystem 106 stores the data in the array 112. The terminating node 124 of the peripheral subsystem 108 may optionally confirm the DMA exchange by issuing a new message to the terminating node 126 of the first processor subsystem 102 as indicated by the dashed line labeled 3.

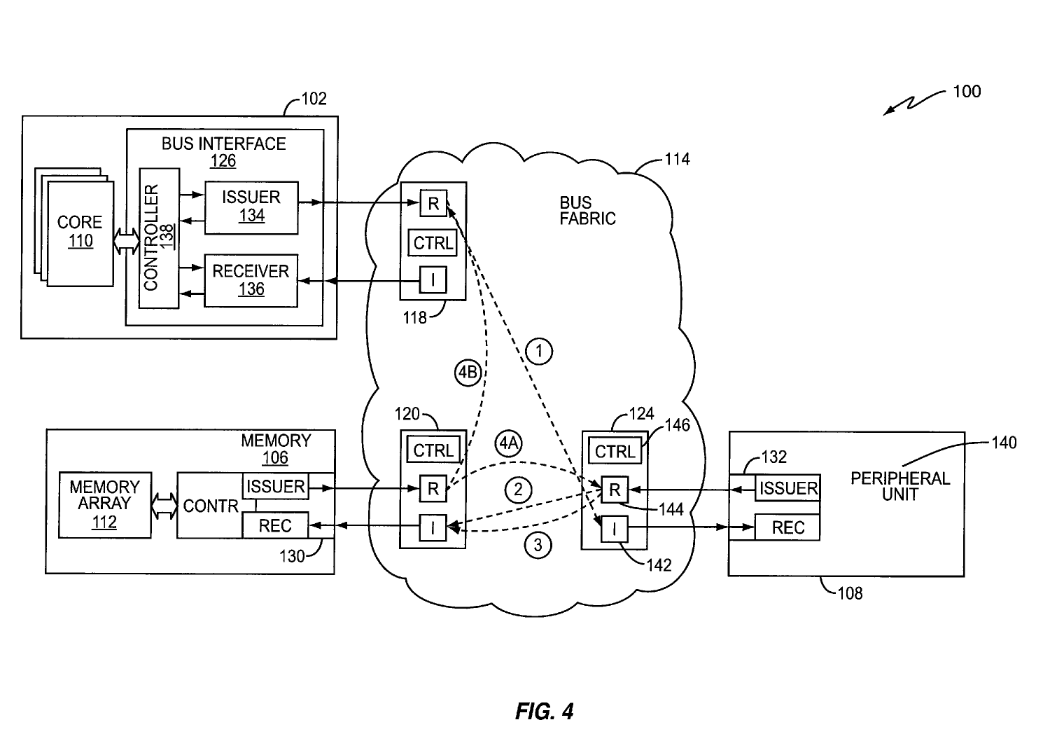

FIG. 4 illustrates another embodiment where the terminating node 126 of the first processor subsystem 102 configures only the terminating node 124 of the peripheral subsystem 108 for a DMA exchange by issuing a message to the peripheral subsystem terminating node 124 as indicated by the dashed line labeled 1. In response, the terminating node 124 of the peripheral subsystem 108 configures the terminating node 120 of the memory subsystem 106 for the forthcoming DMA exchange by issuing a message to the memory subsystem terminating node 120 as indicated by the dashed line labeled 2. The peripheral subsystem terminating node 124 then issues a new message to the memory subsystem terminating node 120 for performing the actual data exchange as indicated by the dashed line labeled 3. The data is stored by the array 112 and the memory subsystem terminating node 120 optionally confirms the DMA exchange to the other terminating nodes 118, 124 as indicated by the dashed lines labeled 4A and 4B.

Non-data flow instructions are also supported. One such instruction is the INITIATE instruction. The INITIATE instruction is a control instruction that causes the subsystem 102-108 of the identified target node to begin a process or routine. The data field 208 of the message contains the details of the process or routine to be executed and any associated parameters. In one embodiment, the INITIATE instruction is used to notify a first terminating node that the peripheral subsystem 108 has an interrupt request for the subsystem of the first terminating node. The first terminating node can then send a message to the terminating node 124 of the peripheral subsystem 108 confirming receipt of the interrupt request. The INITIATE instruction can also be used as part of a daisy-chained operation for initiating a sequence of operations within a pipelined process without processor subsystem intervention, e.g., for various power-down scenarios.

In one embodiment, a control node such as one of the non-terminating nodes 118-124 or a stand-alone node (not shown) manages complex pipeline operations. The control node receives a message such as the INITIATE instruction indicating a number of commands are to be executed in a particular sequence. The control node issues new instructions to different ones of the terminating nodes 126-132 as prior instructions are executed as indicated by status messages received by the control node. In another embodiment, pipelined operations are more distributed. According to this embodiment, each terminating node 126-132 identified in a pipelined operation executes one or more functions assigned to the terminating node and then triggers the next terminating node identified in the pipelined operation to execute one or more additional functions until all functions associated with the pipelined process are executed. The INITIATE instruction can be used to initiate either of these pipeline operations.

Another supported control instruction is the MY_STATUS instruction. The MY_STATUS instruction is used to send data, e.g., via the data field 208 indicating the status of the originating node. This can be used to acknowledge INITIATE instructions, DMA instructions or to communicate between nodes 118-132 for controlling operation of the bus fabric 114. A RESET instruction is a system wide instruction that is broadcast when received by a non-terminating node 118-124 to all attached nodes for executing a cold reset and returning the affected nodes to a default state. The RESET instruction ripples through the peer-to-peer matrix in a set sequence based on where the instruction enters the matrix. The data field 208 may contain additional parameters that can be modified by intervening nodes to achieve a structured reset. The RESET_NODE instruction is similar to the global RESET instruction, but is more selective. The RESET_NODE instruction is used to reset the terminating node 126, 128 of a processor subsystem 102, 104 to a known state determined by the data field. More than one node can be specified. The POWER instruction either sets or unsets nodes 118-132 or subsystems 102-108 into various power states, e.g. sleep, low power, etc.

Any other type of instruction can be supported using the instruction field 202 of the message. The message may have additional fields. FIG. 2 shows an instruction body field 210 where additional instruction data can be stored. An optional data field 212 stores data associated with the processes or routines to be executed by target subsystems 102-108. Yet another field 214 can be used to signal the end of the message. These additional message fields 210-214 can be used for various purposes, including cache-to-cache exchanges between processor subsystems 102, 104, configuring DMA exchanges, managing interrupts, etc. Moreover, the messages can be variable length and divided into a number of words.

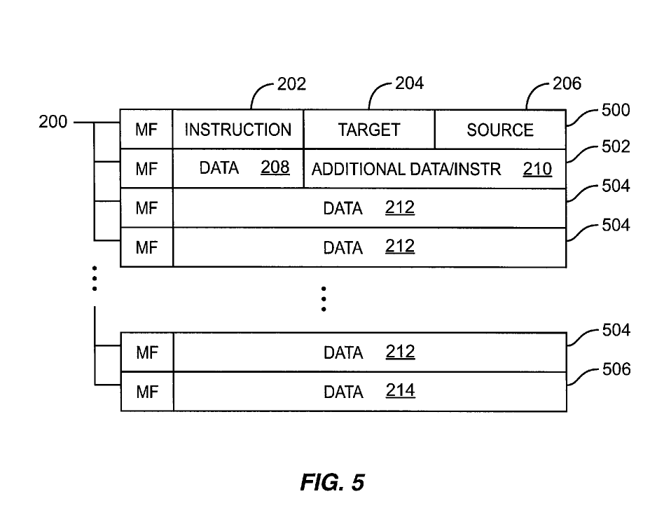

FIG. 5 illustrates an embodiment of a multi-word message. Four basic word types 500-506 are shown. The first word type 500 is the first (and possibly last) word of the message and includes the message format, instruction, target and optional source fields 200-206. The second word type 502 includes the optional instruction/data fields 210 and an optional source identifier field 206. The third word type 504 includes any of the optional data fields 212 provided when the instruction has corresponding data, e.g., when the instruction is a data flow instruction. The last word type 506 includes the end of message field 214 and may be used as an optional instruction or data body. If the message is a single word, then only the first word 500 is used and termination of the burst on the bus fabric 114 indicates no further words should b expected.

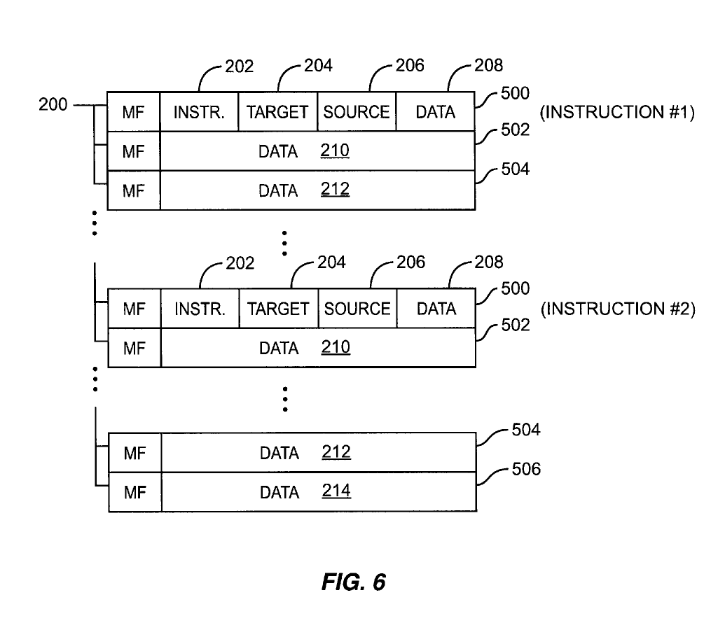

More than one instruction can be included in a message by concatenating multiple instructions to produce a compound message. FIG. 6 illustrates an embodiment of a compound message. The same word types illustrated in FIG. 5 are used here. An additional message body word 500 (and optional data word 502) are provided for each additional instruction included in the compound message. The instructions can be sent to the same target node or different nodes by providing different object identifiers in the target node field 204. Each node that receives the compound message via the peer-to-peer matrix processes only those instructions pertinent to the node.

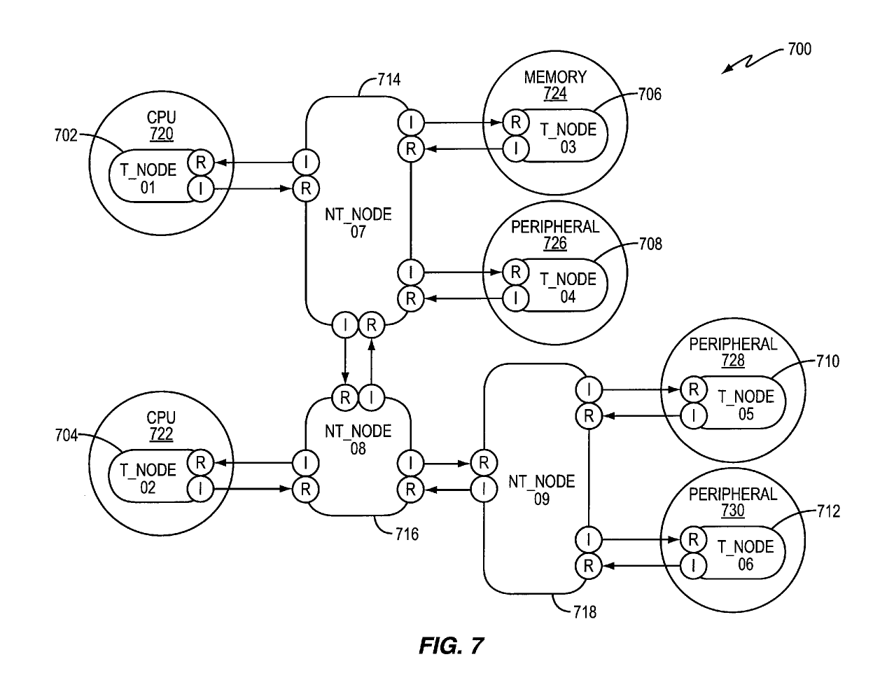

FIG. 7 illustrates an embodiment of the peer-to-peer matrix 700. According to this embodiment, nodes 702-718 can be interconnected in a mesh or star configuration. Each non-terminating node 714-718 controls message routing and arbitration for each subsystem 720-730 coupled to the non-terminating nodes 714-718. For example, the non-terminating node 714 labeled NT_NODE07 serves as a bus fabric interface to one processor subsystem 720, a memory subsystem 724 and a peripheral subsystem 726. The non-terminating node 716 labeled NT_NODE08 serves as a bus fabric interface to a second processor subsystem 722 and the non-terminating node 718 labeled NT_NODE09 serves as an interface to second and third peripheral subsystems 728, 730. Each of the non-terminating nodes 714-718 is connected to at least one other non-terminating node to enable peer-to-peer communication. The non-terminating nodes 714-718 issue messages to each other for maintaining synchronous operation and providing adaptive control. Moreover, the links formed between the non-terminating nodes 714-718 allow the embedded system 100 to control which nodes are visible to other nodes, providing a certain level of security. In addition, parallel paths can be formed between the non-terminating nodes 714-718 to establish simultaneous data paths within the peer-to-peer matrix 700.

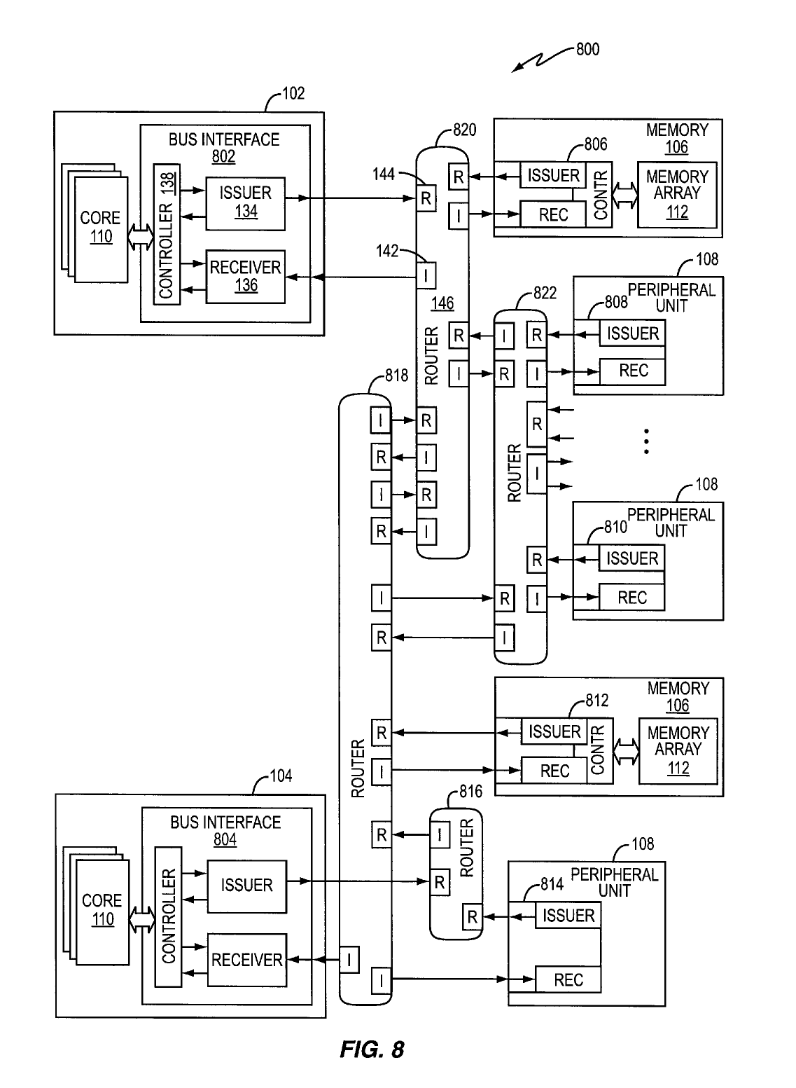

FIG. 8 illustrates another embodiment of the peer-to-peer matrix 800. According to this embodiment, the nodes 802-814 are interconnected in a hierarchical configuration. The interface controllers 146 of the non-terminating nodes 816-822 are implemented as routers that forward messages using routing paths determined based on the object identifiers included in the messages as previously described herein.

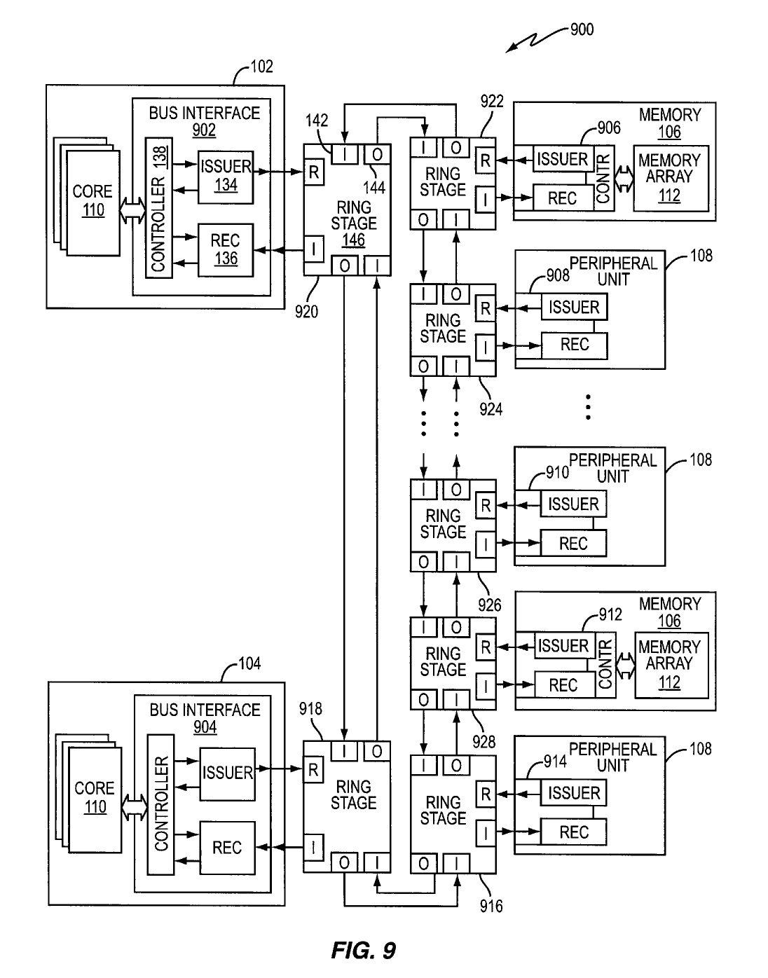

FIG. 9 illustrates yet another embodiment of the peer-to-peer matrix 900 where the nodes 902-928 are interconnected in a ring configuration. According to this embodiment, the interface controllers 146 of the non-terminating nodes 916-928 are implemented as ring stages. Each ring stage 916-928 is coupled to one subsystem 102-108 and two other ring stages. A message is issued by one of the terminating nodes 902-914 and sent to the corresponding ring stage 916-928. The message is then forwarded from stage-to-stage until arriving at the ring stage coupled to the terminating node of interest (i.e., the terminating node identified in the message). This ring stage passes the message to the terminating node of interest for processing.

With the above range of variations and applications in mind, it should be understood that the present invention is not limited by the foregoing description, nor is it limited by the accompanying drawings. Instead, the present invention is limited only by the following claims, and their legal equivalents.

What is claimed is:

1. An embedded system, comprising:
at least one processor, memory and peripheral subsystem, each subsystem having a terminating node configured to issue and receive messages for the subsystem;
a bus fabric interconnecting the subsystems, the bus fabric including a plurality of non-terminating nodes located at different points in the bus fabric and interconnected with the terminating nodes to form a peer-to-peer communication matrix between the subsystems, the non-terminating nodes configured to route the messages over the peer-to-peer matrix so that instructions included in the messages are delivered to the terminating nodes identified in the messages for execution;
wherein each node is assigned one or more unique object identifiers for identifying the nodes; and
wherein the instructions included in the messages identify different control and data flow functions supported by different ones of the subsystems.

2. The embedded system of claim 1, wherein each terminating node comprises an issuer configured to generate new messages and send the new messages to one or more of the non-terminating nodes, a receiver configured to receive messages from one or more of the non-terminating nodes and an interface controller configured to manage interaction between the corresponding subsystem and the issuer and receiver.

3. The embedded system of claim 2, wherein the interface controller is configured to receive commands from the corresponding subsystem, instruct the issuer to generate new messages responsive to the commands, accept decoded messages from the receiver and initiate one or more instructions included in the decoded messages.

4. The embedded system of claim 1, wherein each non-terminating node comprises a receiver configured to route messages received from one of the terminating nodes to one or more other ones of the non-terminating nodes, an issuer configured to receive messages from one or more other ones of the non-terminating nodes and route the received messages to one of the terminating nodes and an interface controller configured to determine how the received messages are routed by the receiver and the issuer based on the unique object identifiers included in the received messages.

5. The embedded system of claim 1, wherein the terminating node of each memory subsystem is configured to send a message to each processor subsystem indicating when a shared region of the memory subsystem has been accessed.

6. The embedded system of claim 5, wherein each memory subsystem is configured to maintain a map identifying different shared regions of the memory subsystem to determine whether a shared region of the memory subsystem has been accessed.

7. The embedded system of claim 1, wherein the non-terminating nodes are configured to route the messages over the peer-to-peer matrix by accessing a link map associating the unique object identifiers with different routing paths and determining arbitration priority based on the associations in the link map.

8. The embedded system of claim 1, wherein one or more routing paths used by the non-terminating nodes to route the messages are modifiable responsive to a portion of the bus fabric being disabled so that messages are not routed through the non-terminating nodes located in the disabled portion of the bus fabric.

9. The embedded system of claim 1, wherein each processor subsystem is assigned multiple unique object identifiers each corresponding to a different function or group of functions supported by the processor subsystem.

10. The embedded system of claim 1, further comprising a dedicated controller inserted in the peer-to-peer matrix configured to reconfigure the peer-to-peer matrix based on changes in subsystem activity.

11. The embedded system of claim 1, wherein the non-terminating nodes are interconnected with the terminating nodes in a hierarchical, star, mesh or ring configuration.

12. The embedded system of claim 1, wherein one or more of the messages comprise a first field identifying one or more of the control and/or data flow functions and a second field identifying the node or nodes that are to execute the functions identified in the first field.

13. The embedded system of claim 12, wherein the one or more messages comprise another field identifying the node that generated the message.

14. The embedded system of claim 12, wherein each message identifying a data write function in the first field further comprises another field including data to be written by the node identified in the second field.

15. The embedded system of claim 1, wherein the terminating node of a processor subsystem is configured to issue a message to the terminating nodes of a peripheral subsystem and a memory subsystem for initiating a data exchange directly between the terminating nodes of the peripheral and memory subsystems over the peer-to-peer matrix.

16. The embedded system of claim 1, wherein the terminating node of a processor subsystem is configured to issue a message to the terminating node of a peripheral subsystem that directs the terminating node of the peripheral subsystem to initiate a data exchange directly with the terminating node of a memory subsystem over the peer-to-peer matrix.

17. The embedded system of claim 1, wherein a first one of the terminating nodes is configured to issue a message including an interrupt instruction to a second one of the terminating nodes, and wherein the second one of the terminating nodes is configured to issue a message to the first one of the terminating nodes in response to the interrupt instruction.

18. The embedded system of claim 1, wherein a first one of the terminating nodes is configured to issue a message including a function call instruction to a second one of the terminating nodes, and wherein the second one of the terminating nodes is configured to initiate one or more functions or routines via the corresponding subsystem responsive to the function call instruction.

19. The embedded system of claim 1, further comprising a control node inserted in the peer-to-peer matrix configured to manage a pipelined operation by issuing new instructions to different ones of the terminating nodes as prior instructions are executed as indicated by status messages received by the control node.

20. The embedded system of claim 1, wherein each terminating node identified in a pipelined operation is configured to execute one or more functions assigned to the terminating node and then trigger the next terminating node identified in the pipelined operation to execute one or more additional functions until all functions associated with the pipelined process are executed.

21. The embedded system of claim 1, wherein each node that receives a message including one or more instructions not supported by the node is configured to issue a message indicating the node is not configured to execute the one or more instructions.

22. A method of controlling low-level functions in an embedded system, comprising:
generating messages at terminating nodes of at least one processor, memory and peripheral subsystem that are targeted to the terminating nodes of different ones of the subsystems based on one or more unique object identifiers assigned to each terminating node;
sending the messages from the terminating nodes of the subsystems to non-terminating nodes of a bus fabric;
routing the messages between different ones of the non-terminating nodes within the bus fabric until each message is received at the non-terminating node coupled to the terminating node to which the message is targeted; and
sending the messages from the bus fabric to the targeted terminating nodes for execution of different control and data flow instructions identified in the messages.

23. The method of claim 22, comprising routing a message generated by a memory subsystem to a processor subsystem for indicating that a shared region of the memory subsystem has been accessed.

24. The method of claim 23, comprising maintaining a map identifying different shared regions of the memory subsystem to determine whether a shared region has been accessed.

25. The method of claim 22, routing the messages between different ones of the non-terminating nodes within the bus fabric comprises routing the messages using a portion of the bus fabric.

26. The method of claim 22, wherein routing the messages between different ones of the non-terminating nodes within the bus fabric comprises:
accessing a link map associating the unique object identifiers with different routing paths; and
determining arbitration priority based on the associations in the link map.

27. The method of claim 22, comprising modifying one or more routing paths used by the non-terminating nodes to route the messages responsive to a portion of the bus fabric being disabled so that messages are not routed through the non-terminating nodes located in the disabled portion of the bus fabric.

28. The method of claim 22, wherein generating the messages comprises broadcasting some of the messages to all terminating nodes.

29. The method of claim 22, comprising reconfiguring the bus fabric based on changes in subsystem activity.

30. The method of claim 22, comprising initiating a data exchange directly between the terminating nodes of a peripheral subsystem and a memory subsystem over the bus fabric.

31. The method of claim 22, comprising directing the terminating node of a peripheral subsystem to initiate a data exchange directly with the terminating node of a memory subsystem over the bus fabric.

32. The method of claim 22, comprising issuing a message indicating when one of the nodes receives a message including one or more instructions not supported by the node.

33. The method of claim 22, comprising generating new messages identifying new instructions for different ones of the terminating nodes after prior instructions complete execution.
